(19) United States
(12) Patent Application Publication
(10) Pub. No.: US 2003/0090361 A1
(43) Pub. Date: May 15, 2003

(54) Leadframe resistance device and process for the same

(76) Inventors: Steven Liu, Hsinchu (TW); Horng-Yih Juang, Chiayi Hsien (TW); Yih-Wen Shiao, Hsinchu (TW); Cheng-Er Fan, Hsinchu Hsien (TW)

Correspondence Address: J.C. Patents, 4 Venture, Suite 250, Irvine, CA, 92618, US

(21) Appl. No.: 10/229,494

(22) Filed: Aug. 27, 2002

Related U.S. Application Data
(62) Division of application No. 09/990,863, filed on Nov. 13, 2001.

(51) Int. Cl. H01C 1/012; H01C 17/00

(52) U.S. Cl. 338/309; 29/610.1; 29/827; 338/68; 338/322

(57) ABSTRACT

A leadframe resistance structure comprises: at least a resistance foil; a plurality of leads, each of the plurality of leads respectively having a first lead surface and an opposite second lead surface, wherein the resistance foil is disposed on the first lead surface of the leads and connected to the leads; and an encapsulating material that encapsulates the resistance foil, and a portion of the first surface of the leads.

### BACKGROUND OF THE INVENTION

1. Field of the Invention

The invention relates to a resistance device and a process to fabricate the same. More particularly, the present invention relates to a resistance device and a process for fabricating the same, capable to be used in testing devices.

2. Description of the Related Art

As the era of information technology progresses, the transmission or processing of information and documents through electronic products are commonly carried out in business processing. Accompanying the progress of technology, many commercial products with more convenient features are promoted, as mobile phones, computers, audio-video articles, while the emphasis is made to miniaturization.

As the semiconductor manufacturing enters the level of 0.18 microns, the testing of electronic products is necessary to ensure the quality of their manufacturing processes. To obtain accurate measurement, highly induction sensitive testing devices are thus fabricated, comprising highly induction sensitive resistance devices, to test circuit currents or voltages. Principal characteristics of such resistance devices are principally very low resistance value (1 to 3 milliohms) and an interaction with heat that must be negligible, which results in a resistance temperature coefficient that should be as close as possible to 0. Highly current sensitive resistance devices can be also used in power supplier, to accurately test and control a current flowing through the power supplier.

Inside the testing device, the resistance value of the resistance device is fixed. The testing device is conventionally either parallel connected to the circuit to be tested to measure voltage difference from a current flowing there through, or series connected to the circuit to be tested to measure flowing current from a voltage difference applied to the testing device.

Referring to FIG. 1, there is schematically shown a conventional structure of the resistance device. The resistance device 100, used in electrical testing, conventionally comprises a ceramic substrate 102, an input node 104, an output node 106 and a resistance foil 108. The resistance foil 108, the input node 104 and output node 106 are arranged between the input node 104 and output node 106 and on a first surface 112 of the ceramic substrate 102. The resistance foil 108 is also respectively connected to the input node 104 and output node 106, while a passivation layer 110 covers the resistance foil 108.

In the resistance device described above, voltage and current sensing locations are undistinguished, by being located on input node 104 and output node 106. Consequently, if the resistance value of the testing device is greater than 10 milliohms, no substantial influence would affect on the accuracy if the testing device. In contrast, if the resistance value of the testing device was less than 10 milliohms, the accuracy of the testing device would be substantially affected and the error on voltage measurement would be substantial. Required standard testing accuracy thus cannot be satisfied.

### SUMMARY OF THE INVENTION

One major aspect of the present invention is to provide a leadframe resistance device that can be used as resistance device of a testing device to increase the accuracy of the current measurement therein.

To attain the foregoing and other objects, the present invention provides a leadframe resistance device that comprises: a resistance foil that has a first foil surface and opposite second foil surface; a plurality of leads, each of the leads respectively having a first lead surface and opposite second lead surface, wherein the leads by the first lead surface thereof are arranged and electrically connected onto the second foil surface of the resistance foil; and an encapsulating material that covers the first foil surface of the resistance foil while exposing the second lead surface of the leads.

Another aspect of the present invention is to provide a process for fabricating a leadframe resistance device that can be used as resistance device of a testing device to increase the accuracy of the current measurement therein.

To attain the foregoing and other objects, the present invention provides a process for fabricating a leadframe resistance device, comprising: providing a resistance foil having a first foil surface and opposite second foil surface; providing a leadframe, the leadframe comprising a plurality of leads, each of which having a first lead surface and opposite second lead surface; and bonding the resistance foil by its second foil surface onto the first lead surface of the leads. An encapsulating material is further formed to cover the resistance foil and the leads.

In one preferred embodiment of the present invention, the encapsulating material is formed by a molding process comprising: disposing the resistance foil with the plurality of leads into a mold, wherein the mold has a cavity that receives the resistance foil and confines therein a portion of the first lead surface of the leads that are tightly maintained inside the mold; and injecting a molding compound inside the cavity to form the encapsulating material. In another preferred embodiment of the present invention, the encapsulating material can be also formed by a spreading process.

After the encapsulating material is formed, a dicing process is further performed to remove portions of the leads extending out of the encapsulating material.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic view illustrating a conventional structure of a resistance device;

FIG. 2 through FIG. 5A are schematic views illustrating various stages in the fabrication process of a leadframe resistance device according to a first embodiment of the present invention; and

FIG. 6 is a schematic view illustrating a leadframe resistance device according to a second embodiment of the present invention.

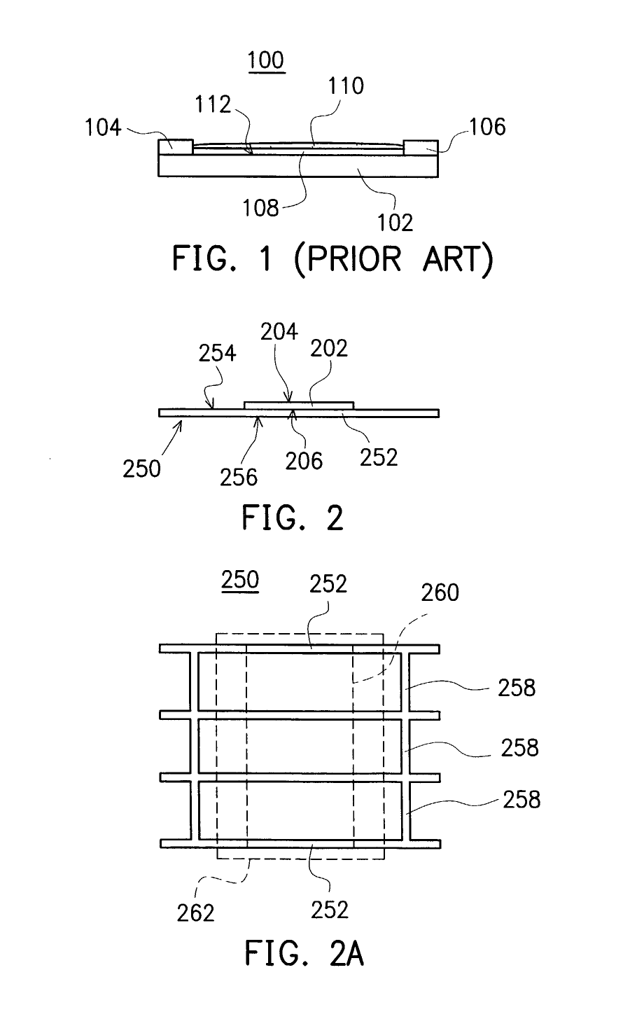

### DESCRIPTION OF THE PREFERRED EMBODIMENTS

The following detailed description of the embodiments and examples of the present invention with reference to the accompanying drawings is only illustrative and not limiting.

Referring now to FIG. 2 through FIG. 5, there are shown schematic views illustrating various stages in the fabrication process of a leadframe resistance device according to a first embodiment of the present invention. With reference to FIG. 2 and FIG. 2A, FIG. 2A being a top view of the leadframe 250 of FIG. 2, first, a resistance foil 202 and a leadframe 250 are provided. The leadframe 250 comprises a plurality of leads 252 and a plurality of dam bars 258. Each of the leads 252 has respectively a first lead surface 254 and an opposite second lead surface 256. In FIG. 2A, dash-lines 260 delimits the region of the resistance foil 202, while dash-lines 262 delimits the region of the encapsulating material subsequently formed. The resistance foil 202 has a first foil surface 204 and opposite second foil surface 206. The resistance foil 202 is made of a material comprising nickel-copper alloys, nickel-chromium alloys or manganese-copper alloys. The resistance foil 202 is connected to the first lead surface 254 of each of the leads 252. The connection can be performed through, for instance, laser welding, spot welding, or contact bonding.

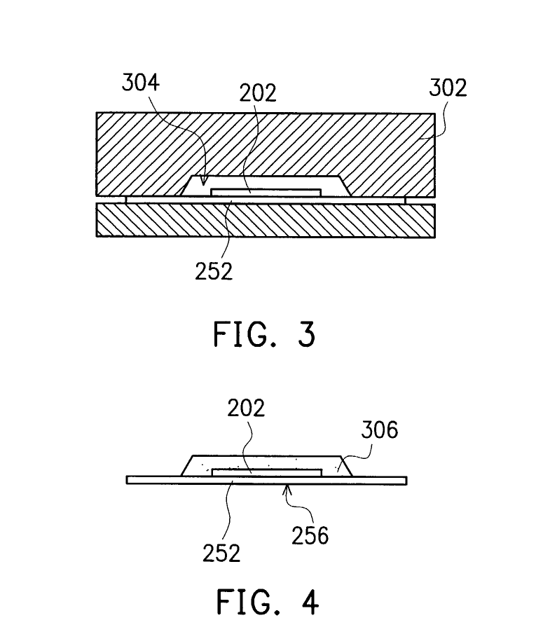

Referring to FIG. 3, the resistance foil 202 and leadframe 250 are then disposed in a mold 302. The mold 302 has a cavity 304 that receives the resistance foil 202 and confines a portion of the first lead surface 254 of the leads 252 around the resistance foil 252. The mold 302 clamps on the leads 252 at the dam bars 258 locations. Conventional molding process is then performed through injecting molding compound into the cavity 304, cooling down, and removal from the mold 302.

Referring to FIG. 4, the encapsulating material 306, formed through the above-described molding process, encapsulates the resistance foil 202 and the first lead surface 254 of the leads 252, while exposing the second lead surface 256 of the leads 252. A dicing is then performed to remove external portions of the leads 252 with the dam bars 258 to form a resistance device.

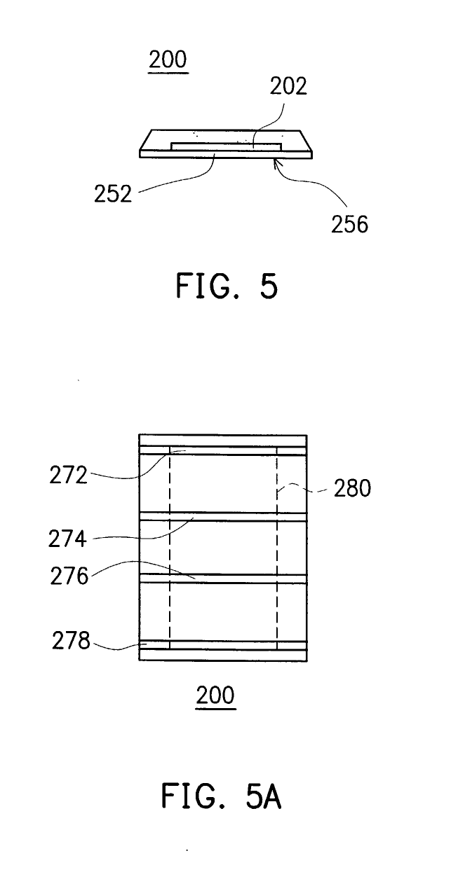

Referring to FIG. 5 and FIG. 5A, wherein FIG. 5A is a bottom view of FIG. 5, the resistance device 200, through the second lead surface 256 of the leads, can be for instance connected to a printed circuit board (not shown), through a surface mounting fashion. In FIG. 5A illustrating an embodiment of the present invention, the resistance device 200 has four leads that are first lead 272, second lead 274, third lead 276 and fourth lead 278. The above number of leads inside the resistance device is only exemplary and not restrictive. Dash-lines 280 delimit the surface area of the resistance foil 202. In use for accurate testing, the first lead 272 and fourth lead 278 can be current nodes, while second lead 274 and third lead 276 can be voltage nodes. When a current flows through the resistance device 200 from the first lead 272 through the fourth lead 278, the corresponding voltage difference can be accurately measured between the second lead 274 and third lead 276. Since the current node location and voltage node location are distinguished in the resistance device of the present invention, the accuracy of the testing device can be increased when the voltage difference is measured.

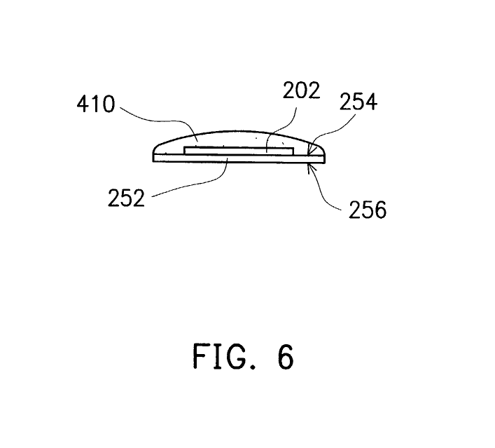

Referring to FIG. 6, there is shown a schematic view illustrating a resistance device according to a second embodiment of the present invention. In the embodiment of the present invention described above, a molding process is used to form the encapsulating material. The use of molding process is only exemplary and not restrictive. A spreading method can be also used to form the encapsulating material 410, wherein the encapsulating material 410 covers the resistance foil 202 and the first lead surface 254 of the leads 252 while exposing the second surface 256. The spreading process can be, for instance, depositing the encapsulating material by spreading while the resistance device relatively effectuates a spinning movement, then, a solidification step is performed to obtain the encapsulating material 410.

From the foregoing description of embodiments and examples of the present invention, at least an advantage of the resistance device of the present invention is an improved accuracy of electrical testing through the resistance device of the present invention. The electrical testing can be more accurate since the current nodes and voltage nodes are distinguishably located.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A leadframe resistance device comprising:
a resistance foil that has a first foil surface and opposite second foil surface; and
a leadframe having a plurality of leads, each of the plurality of leads respectively having a first lead surface and opposite second lead surface, wherein the plurality of leads by their first lead surface is arranged onto the second foil surface of the resistance foil, the resistance foil being connected to respectively each of the plurality of leads.

2. The leadframe resistance device of claim 1, wherein the material of the resistance foil is nickel-copper alloy, nickel-chromium alloy or manganese-copper alloy.

3. The leadframe resistance device of claim 1, wherein the leadframe resistance device further comprises an encapsulating material that covers the first foil surface of the resistance foil while exposing the second lead surface of the plurality of leads.

4. A process for fabricating a leadframe resistance device, comprising:
providing a resistance foil that has a first foil surface and opposite second foil surface;
providing a leadframe that has a plurality of leads, wherein each of the plurality of leads has respectively a first lead surface and second lead surface; and
bonding the second foil surface of the resistance foil onto the first lead surface of each of the plurality of leads, wherein each of the plurality of leads is connected to the resistance foil.

5. The process of claim 4, wherein after the bonding is performed, an encapsulating material is further formed through a method comprising: providing a mold having a cavity therein capable to receive the resistance foil and confine a portion of the first lead surface of the plurality of leads; mounting the resistance foil and leadframe inside the mold; and injecting an encapsulating material inside the cavity of the mold to cover the first foil surface of the resistance foil while exposing the second lead surface of the plurality of leads.

6. The process of claim 4, wherein after the bonding is performed, an encapsulating material is further formed through a spreading method to cover the first foil surface of the resistance foil.

7. The process of claim 4, wherein after the bonding is performed, a dicing is perform to remove portions of the plurality of leads extending out of the encapsulating material.

8. The process of claim 4, wherein the material of the resistance foil comprises nickel-copper alloy, nickel-chromium alloy, or manganese-copper alloy.

9. The process of claim 4, wherein the bonding of the resistance foil with the plurality of leads is performed through laser welding, spot welding, or contact bonding.

10. A leadframe resistance device that is capable to be mounted onto a printed circuit, the printed circuit having a plurality of contact nodes, the leadframe resistance device comprising:
a resistance foil that has a first foil surface and opposite second foil surface;
a leadframe having a plurality of leads, each of the plurality of leads respectively having a first lead surface and opposite second lead surface, wherein the plurality of leads by their first lead surface is arranged onto the second foil surface of the resistance foil, the resistance foil being connected to respectively each of the plurality of leads; and
an encapsulating material that covers the first foil surface of the resistance foil while exposing the second lead surface of the plurality of leads that is capable to be connected to the contact nodes of the printed circuit board.

11. The leadframe resistance device of claim 10, wherein the material of the resistance foil is made of nickel-copper alloy, nickel-chromium alloy, or manganese-copper alloy.
